(19) United States
(12) Patent Application Publication
(10) Pub. No.: US 2012/0291474 A1
(43) Pub. Date: Nov. 22, 2012

(54) AIR CONDITIONING MODULES

(75) Inventors: Michael AINLEY, Derby (GB); Andrew Gaskell, Derby (GB)

(73) Assignee: Frenger Systems Limited, Derby (GB)

(21) Appl. No.: 13/475,080

(22) Filed: May 18, 2012

(30) Foreign Application Priority Data
May 20, 2011 (GB) 1108469.6

(51) Int. Cl. F25D 17/08; B21D 53/02; B23P 11/00; F25D 17/06; F25D 23/00

(52) U.S. Cl. 62/411; 62/412; 29/428; 29/890.035

(57) ABSTRACT

An air conditioning module, for location adjacent a ceiling surface, comprises a heat exchanger which has an upstream side to receive incoming air and a downstream side to discharge conditioned air. The air conditioning module also includes a primary air chamber that is arranged in fluid communication with the downstream side of the heat exchanger and is spaced from the heat exchanger to define a discharge chamber that lies between the primary air chamber and the heat exchanger The primary air chamber includes an air chamber body which has coupled therewith a separately-formed unitary discharge member. The unitary discharge member defines a plurality of primary air discharge ports that are arranged along the length thereof to direct primary air into the discharge chamber and thereby induce incoming air into the heat exchanger.

This invention relates to an air conditioning module and a method of installing an air-conditioning module.

Conventional air conditioning modules are often either integrated within a ceiling structure such that their discharge outlets lie coincident with the exposed surface of the ceiling structure, or are suspended from a ceiling structure so as to lie immediately below the exposed ceiling surface.

Existing air conditioning modules offer very limited options for modifying the manner in which conditioned air is discharged therefrom and so installers have little opportunity to optimise the discharge of conditioned air into a room according to the size of the room and the positioning of the air conditioning module within the room.

There is, therefore, a need for an improved air conditioning module which obviates the aforementioned drawback.

According to an aspect of the invention there is provided an air conditioning module, for location adjacent a ceiling surface, comprising:
a heat exchanger having an upstream side to receive incoming air and a downstream side to discharge conditioned air; and
an elongate primary air chamber arranged in fluid communication with the downstream side of the heat exchanger and spaced from the heat exchanger to define a discharge chamber lying between the primary air chamber and the heat exchanger, the primary air chamber including an air chamber body having coupled therewith a separately-formed unitary discharge member, the unitary discharge member defining a plurality of primary air discharge ports arranged along the length thereof to direct primary air into the discharge chamber and thereby induce incoming air into the heat exchanger.

The inclusion of a separately-formed unitary discharge member allows for the ready interchange of one discharge member with another discharge member having different air transmission characteristics, so as to allow optimisation of the corresponding air conditioning module, without the need to modify or alter the remaining elements of the module.

Optionally the air chamber body includes a single aperture within which the discharge member lies.

The air chamber body may include a plurality of apertures over which the discharge member lies, one or more of the primary air discharge ports defined in the discharge member lying coincident with a corresponding aperture in the air chamber body.

Each of the foregoing embodiments is readily manufacturable while accommodating the ability to readily swap one discharge member for another.

Preferably the discharge member defines at least one blanking portion which lies coincident with an aperture in the air chamber body to close off the said aperture. Such an arrangement allows for a variation in the pitch of discharge ports depending on the cooling or heating requirements of a particular installation.

In a preferred embodiment of the invention the discharge member defines at least first and second primary air discharge ports, the first discharge port having a greater cross-sectional area than the second discharge port. The inclusion of different sized discharge ports allows for selective throttling of the primary air discharged through the ports to tailor the air flow to a given installation.

According to a second aspect of the invention there is provided a method of installing an air conditioning module adjacent a ceiling surface, the air conditioning module including a heat exchanger having an upstream side to receive incoming air and a downstream side to discharge conditioned air, and an elongate primary air chamber arranged in fluid communication with the downstream side of the heat exchanger and spaced from the heat exchanger to define a discharge chamber lying between the primary air chamber and the heat exchanger, the primary air chamber including an air chamber body and the method comprising the step of:
coupling a separately-formed unitary discharge member with the air chamber body, the unitary discharge member defining a plurality of primary air discharge ports arranged along the length thereof to direct primary air into the discharge chamber and thereby induce incoming air into the heat exchanger.

The method shares the advantages associated with the corresponding air conditioning module of the invention.

There now follows a brief description of preferred embodiments of the invention, by way of non-limiting example, with reference being made to the accompanying drawings in which:

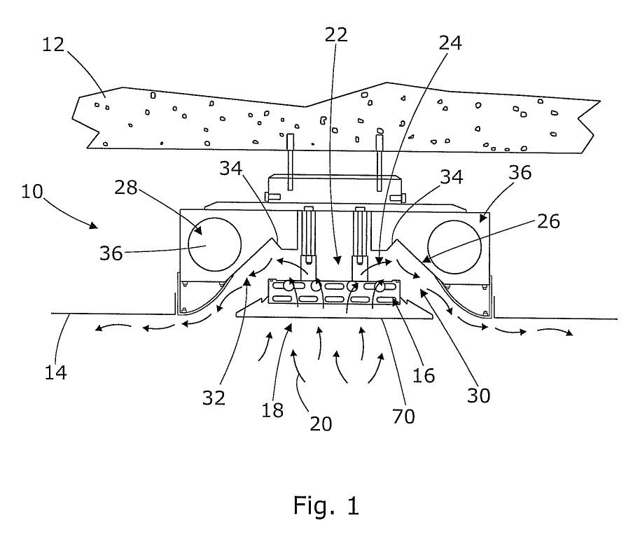

FIG. 1 shows an air conditioning module according to a first embodiment of the invention;

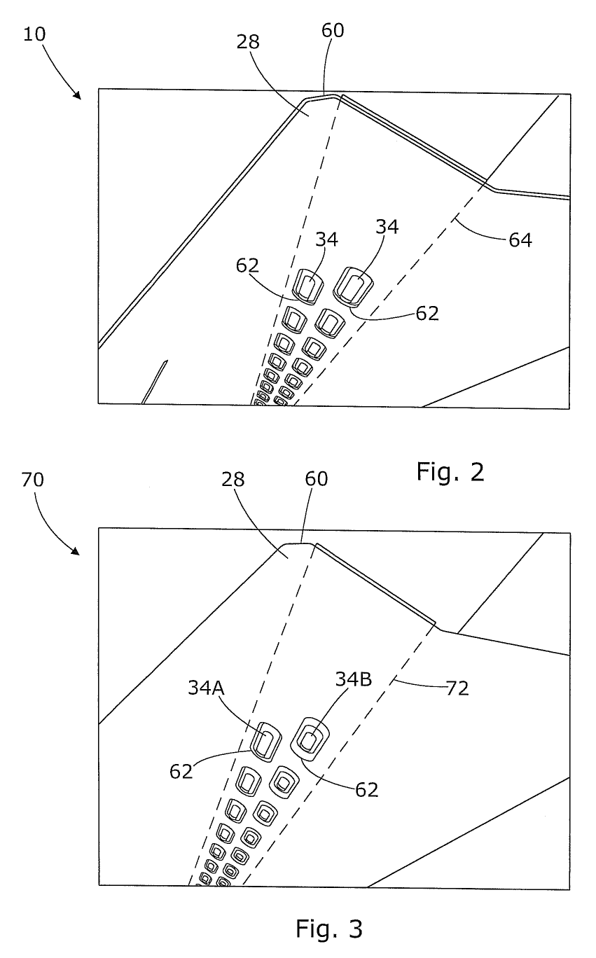

FIG. 2 shows an enlarged portion of the air conditioning module shown in FIG. 1;

FIG. 3 shows an enlarged portion of a second air conditioning module according to the invention;

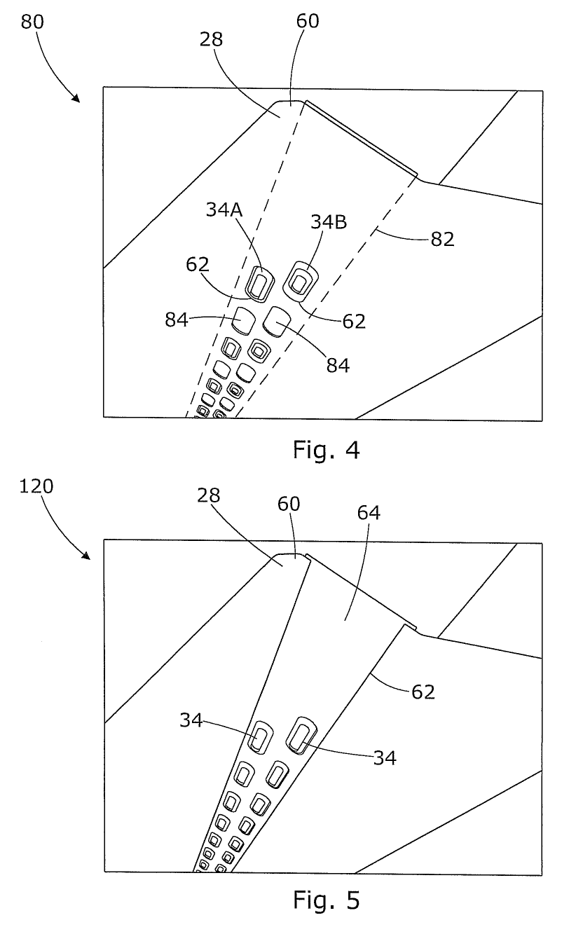

FIG. 4 shows an enlarged portion of a third air conditioning module according to the invention;

FIG. 5 shows an enlarged portion of a fourth air conditioning module according to the invention;

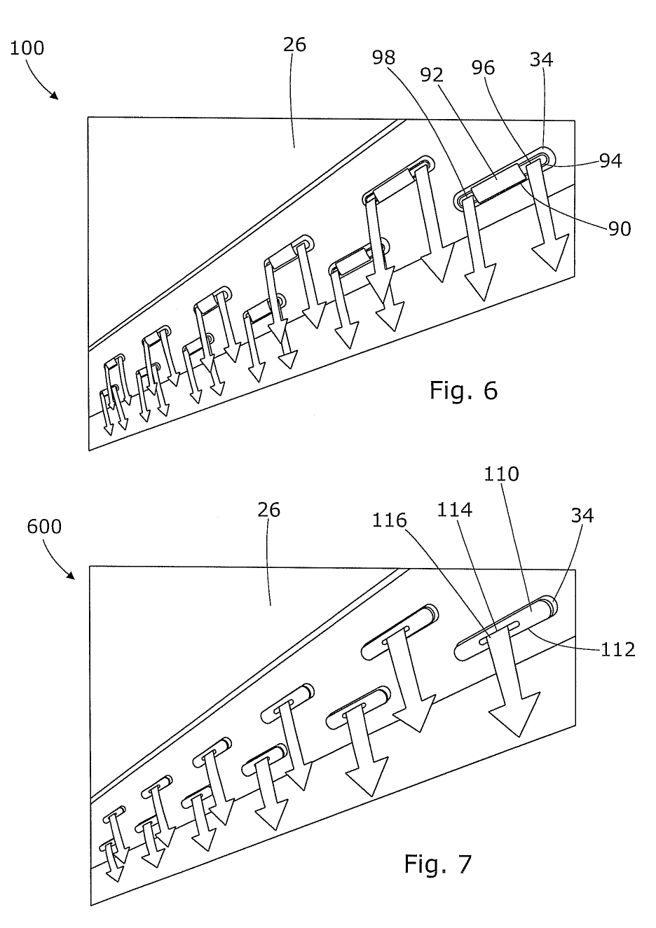

FIG. 6 shows an enlarged portion of another air conditioning module arrangement; and

FIG. 7 shows an enlarged portion of a further air conditioning module arrangement.

An air conditioning module according to a first embodiment of the invention is designated generally by the reference numeral 10.

The air conditioning module 10 is shown integrated within a ceiling structure 12 such that it lies coincident with an exposed ceiling surface 14 of the ceiling structure 12. The air conditioning module could, however, be suspended below the ceiling surface 14.

The air conditioning module 10 includes a heat exchanger 16 that has an upstream side 18 to receive incoming air 20 and a downstream side 22 to discharge conditioned air 24.

The module 10 also includes first and second primary air chambers 26, 28. Other embodiments of the invention (not shown) may include only a single primary air chamber.

Each primary air chamber 26, 28 is arranged in fluid communication with the downstream side 22 of the heat exchanger 16 and is spaced from the heat exchanger 16 to define respective first and second discharge chambers 30, 32 which lie between the given primary air chamber 26, 28 and the heat exchanger 16.

Each primary air chamber 26, 28 includes an air chamber body 60 which includes a plurality of apertures 62, as shown in FIG. 2 (which shows an enlarged portion of the second primary air chamber 28).

The air chamber body 60 has coupled therewith a unitary discharge member 64 which defines a plurality of primary air discharge ports 34 that are arranged along the length thereof. The unitary discharge member 64 is separately formed from the air chamber body 60. In addition, each of the discharge ports 34 defined in the discharge member 64 lies coincident with a corresponding aperture 62 in the air chamber body 60.

As such, in use each of the primary air discharge ports 34 is able to direct primary air 36, i.e. pressurised air from a separate source such as an air handling unit or a supply fan, into the corresponding discharge chamber 30, 32 so as to induce incoming air into the heat exchanger 16.

FIG. 3 shows an enlarged portion of a second primary air chamber 28 in an air conditioning module 70 according to a second embodiment of the invention.

The second primary air chamber 28 includes an air chamber body 60 with which is coupled a second unitary discharge member 72. The second unitary discharge member 72 defines first and second primary air discharge ports 34A, 34B. The first primary air discharge port 34A has a greater cross-sectional area than the second primary air discharge port 34B.

An enlarged portion of a second primary air chamber 28 in an air conditioning module 80 according to a third embodiment of the invention is shown in FIG. 4.

The third air conditioning module 80 includes a second primary air chamber 28 that has an air chamber body 60 to which is coupled a third unitary discharge member 82. The third discharge member 82 defines first and second primary air discharge ports 34A, 34B and, additionally, a plurality of blanking portions 84. Each blanking portion 84 lies coincident with a corresponding aperture 62 in the air chamber body 60 so as to act to close off the said aperture 62. Other combinations and arrangements of first and second discharge ports 34A, 34B and blanking portions 84 are also possible.

FIG. 5 shows an enlarged portion of a fourth air conditioning module 120 according to another embodiment of the invention. The air chamber body 60 in the second primary air chamber 28 of the fourth air conditioning module 120 includes a single aperture 62 over which a first discharge member 64 lies. In other embodiments of the invention (not shown) another discharge member, e.g. one of the second or third discharge members 72, 82, may lie within the single aperture 60.

FIG. 6 shows an enlarged portion of a first primary air chamber 26 in another air conditioning module arrangement 100. A second primary air chamber 28 in the other air conditioning module 100 is a mirror image of the first primary air chamber 26.

The first primary air chamber 26 is elongate and includes a plurality of primary air discharge ports 34 directly formed therewithin and arranged along its length to direct primary air 36 into the associated first discharge chamber 30.

In the arrangement shown, each discharge port 34 includes a first throttle member 90 that is received therein to reduce the flow of primary air 36 through the discharge port 34.

In other arrangement (not shown) not all of the discharge ports 34 includes a corresponding first throttle member 90.

Each first throttle member 90 includes a first throttle body 92 that cooperates with the corresponding primary air discharge port 34 to partially obstruct the discharge port 34.

In particular, in the arrangement shown in FIG. 6, each primary air discharge port 34 defines a discharge aperture 94 and the first throttle body 92 of each first throttle member 90 is shaped to lie spaced from first and second portions 96, 98 of the discharge aperture 94 when received in the discharge port 34.

The first and second portions 96, 98 of the discharge aperture 94 are spaced from one another and lie at opposite ends of the first throttle body 92. In other arrangements the first throttle body 92 may be shaped to lie spaced from only one portion of the discharge aperture 94, or from three or more portions of the discharge aperture 94. The or each such portions of the discharge aperture 94 may also have different arrangements relative to one another and the throttle body 92.

Corresponding primary air discharge ports 34 and first throttle bodies 92 include mutually cooperable formations (not shown) to secure one to the other. In the arrangement shown each first throttle body 92 includes a recess which extends around its perimeter to receive the discharge aperture 94 perimeter of the corresponding primary air discharge port 34. Other mutually cooperable formations such as resiliently deformable legs and/or clips are also possible.

Each first throttle body 92 is removably received in the corresponding primary air discharge port 34. In the arrangement shown such functionality is provided by the inclusion of a resiliently deformable throttle body 92.

In use, directing primary air 36 into the first discharge chamber 30 induces incoming air 20 into the heat exchanger 16. The inclusion of respective first throttle members 90 reduces the overall volume of primary air 36 flowing into the first discharge chamber 30 (compared to the volume of primary air 36 flowing into the first discharge chamber 30 if no throttle members 90 are present) while maintaining a continuous discharge of primary air 36 along the length of the first primary air chamber 26.

The ability to reduce the overall volume of primary air 36 allows for an optimisation of the extent to which incoming air 20 is induced into the heat exchanger, while maintaining a continuous discharge of primary air 36 along the length of the first primary air chamber 26 helps to ensure the whole of the heat exchanger 16 is utilised for conditioning the incoming air 20, and thereby helps to ensure efficient operation of the heat exchanger.

FIG. 7 shows an enlarged portion of a first primary air chamber 26 in further air conditioning module arrangement 600. A second primary air chamber 28 in the further air conditioning module 600 is a mirror image of the first primary air chamber 26.

The first primary air chamber 26 in the further air conditioning module arrangement 600 shares a number of common features with the first primary air chamber 26 in the other air conditioning module arrangement 100 and these are designated using the same reference numerals.

The first primary air chamber 26 shown in FIG. 7 is again elongate and includes a plurality of primary air discharge ports 34 that are formed directly therein and arranged along its length to direct primary air 36 into the associated first discharge chamber 30.

Each discharge port 34 includes a second throttle member 110 that is received therein to reduce the flow of primary air 36 through the discharge port 34.

In other arrangements (not shown) not all of the discharge ports 34 need include a corresponding second throttle member 110.

Each second throttle member 110 includes a second throttle body 112 which cooperates with the corresponding primary air discharge port 34 to partially obstruct the discharge port 34.

In particular, in the arrangement shown in FIG. 7, each second throttle body 112 includes a throttle aperture 114 passing therethrough. Each throttle aperture 114 defines a conduit 116 for primary air to pass through the second throttle body 112. Each conduit 116 has a smaller cross-sectional area that the cross-sectional area of the corresponding primary air discharge port 34.

In the arrangement shown the throttle aperture 114 is positioned centrally within the second throttle body 112. In other arrangements the throttle aperture 114 may be positioned relative to the throttle body 112 in a different manner, and still further arrangements may include a plurality of throttle apertures 114 in each second throttle body 112.

In use the inclusion of respective second throttle members 110 again reduces the overall volume of primary air 36 flowing into the first discharge chamber 30 while maintaining a continuous discharge of primary air 36 along the length of the first primary air chamber 26.

1. An air conditioning module, for location adjacent a ceiling surface, comprising:
a heat exchanger having an upstream side to receive incoming air and a downstream side to discharge conditioned air; and
an elongate primary air chamber arranged in fluid communication with the downstream side of the heat exchanger and spaced from the heat exchanger to define a discharge chamber lying between the primary air chamber and the heat exchanger, the primary air chamber including an air chamber body having coupled therewith a separately-formed unitary discharge member, the unitary discharge member defining a plurality of primary air discharge ports arranged along the length thereof to direct primary air into the discharge chamber and thereby induce incoming air into the heat exchanger.

2. An air conditioning module according to claim 1 wherein the air chamber body includes a single aperture within which the discharge member lies.

3. An air conditioning module according to claim 1 wherein the air chamber body includes a plurality of apertures over which the discharge member lies, one or more of the primary air discharge ports defined in the discharge member lying coincident with a corresponding aperture in the air chamber body.

4. An air conditioning module according to according to claim 3 wherein the discharge member defines at least one blanking portion which lies coincident with an aperture in the air chamber body to close off the said aperture.

5. An air conditioning module according to claim 1 wherein the discharge member defines at least first and second primary air discharge ports, the first discharge port having a greater cross-sectional area than the second discharge port.

6. A method of installing an air conditioning module adjacent a ceiling surface, the air conditioning module including a heat exchanger having an upstream side to receive incoming air and a downstream side to discharge conditioned air, and an elongate primary air chamber arranged in fluid communication with the downstream side of the heat exchanger and spaced from the heat exchanger to define a discharge chamber lying between the primary air chamber and the heat exchanger, the primary air chamber including an air chamber body and the method comprising the step of:
coupling a separately-formed unitary discharge member with the air chamber body, the unitary discharge member defining a plurality of primary air discharge ports arranged along the length thereof to direct primary air into the discharge chamber and thereby induce incoming air into the heat exchanger.

7-8. (canceled)
